(19) United States
(12) Patent Application Publication
(10) Pub. No.: US 2019/0279128 A1
(43) Pub. Date: Sep. 12, 2019

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Takehito WATANABE, Kanagawa (JP)

(73) Assignee: FUJI XEROX CO., LTD., TOKYO (JP)

(21) Appl. No.: 16/285,243

(22) Filed: Feb. 26, 2019

(30) Foreign Application Priority Data
Mar. 9, 2018 (JP) 2018-042766

(51) Int. Cl. G06Q 10/06

(52) U.S. Cl. CPC G06Q 10/0635; G06Q 10/063114; G06Q 10/0633; G06Q 10/06316

(57) ABSTRACT

An information processing device includes an acquiring unit and a presenting unit. The acquiring unit acquires communication information related to a project, phase information indicating a phase of the project, and model information of communication required for the phase of the project. The presenting unit presents a communication status in the phase of the project on the basis of the model information corresponding to the phase information and on the basis of the communication information.

### CROSS-REFERENCE TO RELATED APPLICATIONS

This application is based on and claims priority under 35 USC 119 from Japanese Patent Application No. 2018-042766 filed Mar. 9, 2018.

### BACKGROUND

### (i) Technical Field

The present disclosure relates to an information processing device and a non-transitory computer readable medium.

### (ii) Related Art

Japanese Unexamined Patent Application Publication No. 2004-054606 is directed to supporting the prediction of a project risk related to communication between project members and discloses the following. Terminals of the project members and a server are present in a network. The server includes a communication-information storing unit and a computation processing unit. The communication-information storing unit stores information including a transmitter identifier and a transmission date and time according to message. In response to transmission of a message from any of the terminals, the computation processing unit stores communication information related to the message in the communication-information storing unit, and, on the basis of information stored in the communication-information storing unit, outputs analysis information indicating the number of message transmissions from a project member in chronological order for each project member.

Japanese Unexamined Patent Application Publication No. 2004-127140 is directed to supporting the prediction of a project risk related to communication between project members and discloses the following. A server includes a communication-information storing unit and a computation processing unit. The communication-information storing unit stores information including a transmitter identifier, a transmission date and time, a receiver identifier, and a reception date and time according to message. In response to transmission of a message from any terminal, the computation processing unit stores communication information related to the message in the communication-information storing unit, and, on the basis of information stored in the communication-information storing unit, outputs analysis information indicating the number of message transmissions from a project member in chronological order for each project member.

Japanese Patent No. 5212604 is directed to providing a project risk detecting system, a project risk detecting method, and a program that can present information of a risk of a project from data related to the project to a user, and discloses the following. The project risk detecting system includes an intension determining unit, a topic determining unit, an extraction condition storing unit, and a speech identifying unit. The intention determining unit determines an intension of a speech included in a text sentence related to the project on the basis of a predetermined relationship between an expression in text and the intention. The topic determining unit determines a topic of the speech included in the text sentence on the basis of a predetermined relationship between the expression in text and the topic. The extraction condition storing unit stores a risk sentence extraction condition constituted by an appearance pattern of the intension of a plurality of speeches and a topic. The speech identifying unit collates the intention determined by the intension determining unit and the topic determined by the topic determining unit with a risk sentence extraction condition stored in the extraction condition storing unit and identifies, as a risk speech, a speech corresponding to the intention and the topic that match the risk sentence extraction condition.

### SUMMARY

In order to conduct a project by a group of a plurality of members, the members of the project need to communicate with each other as appropriate. Such communication between the members is enabled by, for example, email or the like, and the number of communications can be counted. However, the number of communications alone is not sufficient for predicting a risk of the project, for example. The project includes a plurality of phases, and appropriate communication differs in each of the phases.

Aspects of non-limiting embodiments of the present disclosure relate to providing an information processing device and a non-transitory computer readable medium. The information processing device can present a communication status by using model information corresponding to a phase and by using communication information in order to present the communication status in the phase of a project.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing device including an acquiring unit and a presenting unit. The acquiring unit acquires communication information related to a project, phase information indicating a phase of the project, and model information of communication required for the phase of the project. The presenting unit presents a communication status in the phase of the project on the basis of the model information corresponding to the phase information and on the basis of the communication information.

### BRIEF DESCRIPTION OF THE DRAWINGS

An exemplary embodiment of the present disclosure will be described in detail based on the following figures, wherein:

FIG. 1 is a conceptual module configuration diagram of a configuration example according to the exemplary embodiment;

FIG. 2 illustrates a system configuration example using the exemplary embodiment;

FIGS. 3A and 3B illustrate processing examples according to the exemplary embodiment;

FIG. 4 is a flowchart illustrating a processing example according to the exemplary embodiment;

FIG. 5 illustrates an example of a phase that is a processing target according to the exemplary embodiment;

FIG. 6 illustrates a data structure example of a project planning table;

FIG. 7 illustrates a data structure example of a model information table;

FIG. 8 illustrates a data structure example of a communication information table;

FIG. 9 illustrates a data structure example of an outcome information table;

FIG. 10 is a flowchart illustrating a processing example according to the exemplary embodiment;

FIG. 11 is a flowchart illustrating a processing example according to the exemplary embodiment;

FIG. 12 is a flowchart illustrating a processing example according to the exemplary embodiment;

FIG. 13 is a flowchart illustrating a processing example according to the exemplary embodiment; and

FIG. 14 is a block diagram illustrating a hardware configuration example of a computer implementing the exemplary embodiment.

### DETAILED DESCRIPTION

Now, an exemplary embodiment for implementing the present disclosure will be described below with reference to the drawings.

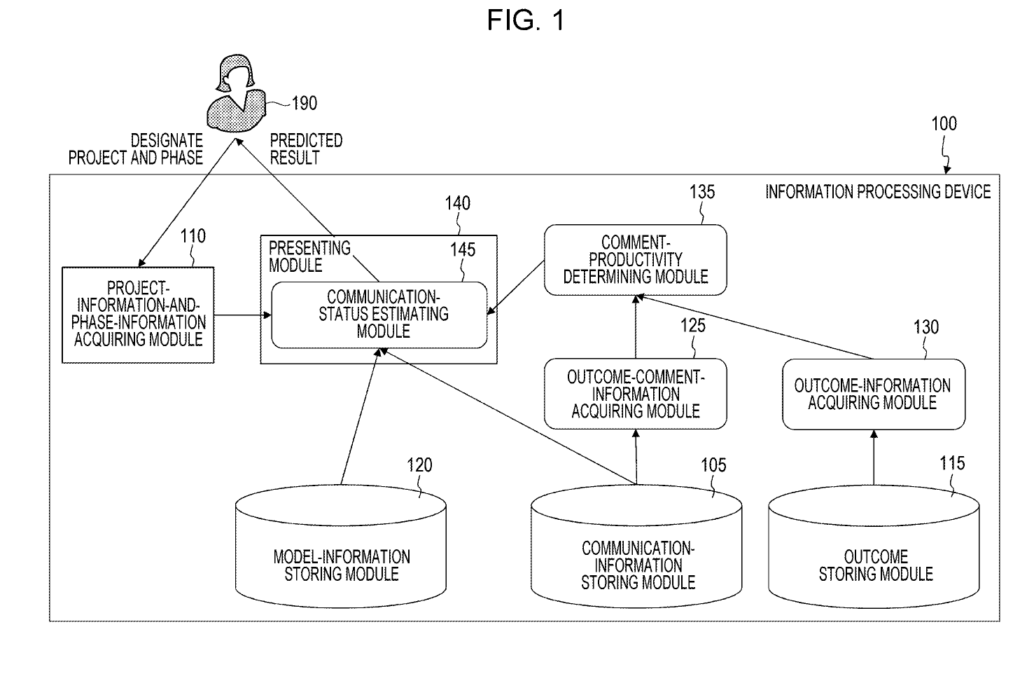

FIG. 1 is a conceptual module configuration diagram of a configuration example according to the exemplary embodiment.

Note that the term “module” generally means a logically separable component of software (computer program), hardware, or the like. Accordingly, a module in the exemplary embodiment refers to not only a module in a computer program but also a module in a hardware configuration. Therefore, the exemplary embodiment will also illustrate a computer program for realizing the function of such a module (a program for causing a computer to execute each step, a program for causing a computer to function as each unit, or a program for causing a computer to realize each function), a system therefor, and a method therefor. For the convenience of description, “store Y”, “cause X to store Y”, or a similar expression will be used. In an exemplary embodiment illustrating a computer program, such an expression means to cause a memory device (X) to store Y or to perform control in such a manner as to cause a memory device (X) to store Y. Modules and functions may correspond to each other in a one-to-one relationship. Alternatively, in implementation, a single program may realize a single module or a plurality of modules. Conversely, a plurality of programs may realize a single module. A plurality of modules may be executed by a single computer, or a single module may be executed by a plurality of computers in a distributed or parallel environment. In addition, a single module may include another module. The term “connect” is herein used to describe a physical connection or a logical connection (e.g., data transfer, instruction transmission, data cross-reference, or log in). The term “predetermined” means a state where something is determined prior to a target process and includes the meaning of not only being determined before the starting of a process according to the exemplary embodiment but also being determined before the target process even after the starting of a process according to the exemplary embodiment, in accordance with the present or previous status and conditions. If there are a plurality of “predetermined values”, these values may be mutually different values, or two or more values may be the same (it is needless to say that all the values may be the same). In addition, an expression such as “if A, B” is used to indicate that whether or not A is determined, and if it is determined that A, then B. However, this does not apply to the case where the determination as to whether or not A is unnecessary. Furthermore, a list of things such as “A, B, and C” is a list of examples unless otherwise specified, and only one of them (e.g., only A) may be selected therefrom.

Furthermore, a system or a device may be configured by connecting a plurality of computers, hardware components, devices, and the like to one another by using a communication means, such as a network (including one-to-one-correspondence communication connection), or may be configured by a single computer, hardware component, device, and the like. Note that the terms “system” and “device” are used as synonyms. It may be needless to say that the term “system” does not mean a social mechanism (social system), which is settled by humans.

Furthermore, in the case where a plurality of processes are performed by the respective modules or within a module, target information is read from a memory device in each process, and after the process has been performed, the process result is written to the memory device. Accordingly, description of the reading of information from the memory device before a process and the writing of information to the memory device after the process will be omitted in some cases. Note that examples of the memory device herein may include a hard disk, a random access memory (RAM), an external memory medium, a memory device connected via a communication line, a register in a central processing unit (CPU), and the like.

An information processing device 100 according to the exemplary embodiment supports the development of a project conducted by a group of a plurality of members and includes, as illustrated in the example in FIG. 1, a communication-information storing module 105, a project-information-and-phase-information acquiring module 110, an outcome storing module 115, a model-information storing module 120, an outcome-comment-information acquiring module 125, an outcome-information acquiring module 130, a comment-productivity determining module 135, and a presenting module 140.

In particular, the information processing device 100 estimates a risk of project delay by using communication information between the members. Specifically, in response to a change of communication required for a phase of the project, a communication status can be estimated (e.g., a risk can be predicted) on the basis of communication details. Note that the phase is a unit obtained by dividing the entire project into terms or scales that are shorter or smaller than the project.

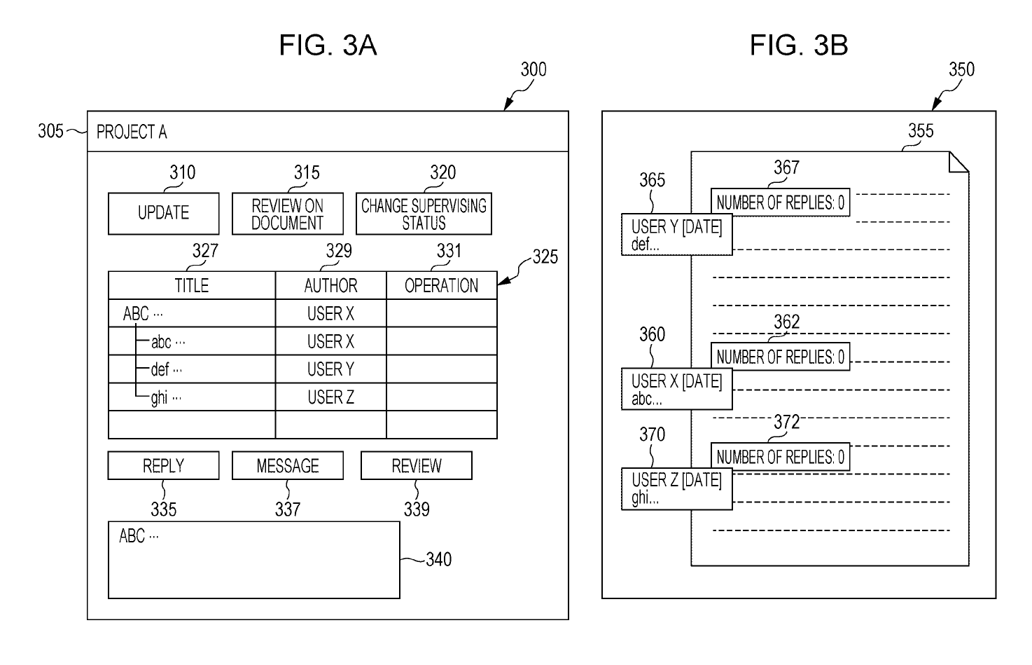

The communication-information storing module 105 is connected to the outcome-comment-information acquiring module 125 and a communication-status estimating module 145 of the presenting module 140. The communication-information storing module 105 stores information related to communication performed between the members (e.g., supervisors) of the project. Examples of the information related to communication include information of email transmitted between the members, information of conversation on a chat system, information transmitted by using a communication function of a social networking service (SNS), a comment pasted onto a document, and the like. Examples of the comment pasted onto a document include text information written on an annotation (electronic sticky note) imitating a sticky note that can be pasted onto a document. Readers of the document communicate with each other by writing down a comment like pasting an electronic sticky note onto the document. The term “comment pasted onto a document” will be described later with reference to FIG. 3B.

The project-information-and-phase-information acquiring module 110 is connected to the communication-status estimating module 145 of the presenting module 140. The project-information-and-phase-information acquiring module 110 receives designation of a project (specifically, a project ID or the like) and a phase (specifically, a phase ID or the like) by an operation of a user 190.

The outcome storing module 115 is connected to the outcome-information acquiring module 130. The outcome storing module 115 stores a document that is an outcome of the project. The term “document” (also referred to as a file) includes text data, numerical data, figure data, image data, video data, audio data, and data similar to any of them, alone or in combination, and is to be stored, edited, and searched for, for example, to be exchanged as an individual unit between systems or users. Specifically, the term “document” includes a document created by using a document creating program, an image read by an image reading device (e.g., a scanner), a Web page, and the like. Communication information may be associated with the document. Examples of the communication information to be associated with the document include communication information in communication performed before creation of the document, communication information in a review of the created document, and the like. Specifically, the above-described electronic sticky note or the like can be pasted onto the document.

The model-information storing module 120 is connected to the communication-status estimating module 145 of the presenting module 140. The model-information storing module 120 stores model information that is necessary for the communication-status estimating module 145 to estimate the communication status. The model information herein defines a condition that is necessary to develop the project (or a condition under which a risk is generated with a high possibility). The model information may also define a target (feature) for determining the condition. In addition, the model information is stored in the model-information storing module 120, corresponding to the phase of the project.

Specifically, a feature of the communication information to be extracted is set corresponding to the phase in the model information.

For example, a first specific example of the “feature of the communication information to be extracted” is a comment (or a reply to the comment) on a document that is an outcome in a phase if the phase is a document creating phase. The extraction of the feature may be set in the model information. A second specific example of the “feature of the communication information to be extracted” is information indicating whether a consensus is reflected on a document that is an outcome in a phase if the phase is a consensus creating phase. The extraction of the feature may be set in the model information. Furthermore, the extraction of information indicating a discussion in a phase as the feature of the communication information may be set in the model information if the phase is a discussion phase.

A member of the project may be set as the feature in the model information. Specifically, if the phase is the document creating phase, a supervisor being involved in creating the document may be set in the model information. If the phase is the consensus creating phase, a project manager participating in a meeting for creating a consensus may be set in the model information. If the phase is the discussion phase, greater than or equal to X % of members participating in the project may be set in the model information.

The model information is a condition for determining a determination standard for predicting a risk on the basis of the communication information in accordance with the phase. By varying the model information in accordance with the phase, it is possible to vary a method for predicting a risk by using the model information.

For example, if the phase is a development planning phase, the model information is “information designating estimation of a communication status (e.g., prediction of a risk) on the basis of ‘the total number of threads, the number of threads in which a message determined as a consensus (conclusion) is written, and a ratio therebetween’ (an example of the feature of the communication information)”.

Specifically, the determination is made as follows.

total number of threads: 100

number of threads including consensus (conclusion): 25

ratio therebetween: 25%

threshold: 20%

In this example, since the ratio is no less than the threshold, it is determined that no risk is present.

For example, if the phase is a specification creating phase, the model information is “information designating estimation of a communication status (e.g., prediction of a risk) on the basis of ‘the number of comments on the outcome, the number of pages of the outcome, and a ratio therebetween’ (an example of the feature of the communication information)”.

Specifically, the determination is made as follows.

number of comments on outcome (document): 40

number of pages of outcome (document): 10

value obtained by dividing number of comments by number of pages: 4

threshold: 5

In this example, since the value is less than the threshold, it is determined that a risk is present.

The outcome-comment-information acquiring module 125 is connected to the communication-information storing module 105 and the comment-productivity determining module 135. The outcome-comment-information acquiring module 125 acquires, from the communication-information storing module 105, communication information corresponding to the project ID and the phase ID that are received by the project-information-and-phase-information acquiring module 110.

The outcome-information acquiring module 130 is connected to the outcome storing module 115 and the comment-productivity determining module 135. The outcome-information acquiring module 130 acquires, from the outcome storing module 115, a document that is an outcome corresponding to the project ID and the phase ID that are received by the project-information-and-phase-information acquiring module 110.

The comment-productivity determining module 135 is connected to the outcome-comment-information acquiring module 125, the outcome-information acquiring module 130, and the communication-status estimating module 145 of the presenting module 140. The comment-productivity determining module 135 determines the productivity of comments on the basis of the document acquired by the outcome-information acquiring module 130 and the communication information associated with the document.

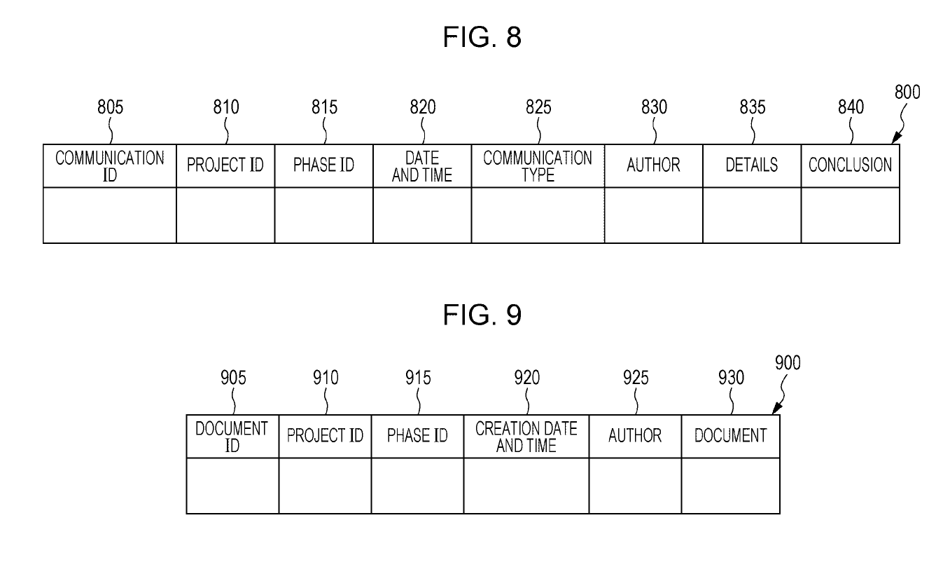

For example, by comparing the number of comments (or volume of data) in the communication information associated with the document with a predetermined threshold, if the number of comments is less than or equal to the threshold, the comment-productivity determining module 135 may determine that the “discussion is insufficient”. Note that the communication information includes the type of communication (a communication type column 825 of a communication information table 800 described later in the example in FIG. 8), and it can be determined that certain information is a comment on the basis of the type of communication. A specific example of the comment is a review comment or the like.

Subsequently, by using the productivity of comments, which is the determination result of the comment-productivity determining module 135, the communication-status estimating module 145 may predict a risk.

The presenting module 140 includes the communication-status estimating module 145. The presenting module 140 presents the communication status in the phase of the project to the user 190 on the basis of the model information corresponding to the phase information and on the basis of the communication information. Specifically, the communication status is displayed on a display device such as a liquid crystal display. In addition to the display on the display device, the communication status may be output as a three-dimensional (3D) image, may be printed by a printer, may be output as audio information from an audio output device such as a speaker, or may be output as vibration. Any of these outputs may be combined.

The presenting module 140 may also present a predicted result of the communication-status estimating module 145 as the communication status.

In addition, the presenting module 140 may also present the communication status in the phase of the project on the basis of the model information corresponding to the phase information and on the basis of member information.

Furthermore, the presenting module 140 may present the communication status in accordance with a first phase and a second phase. The first phase and the second phase may be any phase as long as they are included in the same project. For example, the first phase and the second phase may be selected by a user operation or may be predetermined phases.

In addition, the presenting module 140 may present, as the communication status, information as to whether the first phase and the second phase are different from each other.

The communication-status estimating module 145 is connected to the communication-information storing module 105, the project-information-and-phase-information acquiring module 110, the model-information storing module 120, and the comment-productivity determining module 135. The communication-status estimating module 145 gives the predicted result to the user 190.

In addition, the communication-status estimating module 145 acquires the communication information related to the project, the phase information indicating the phase of the project, and the model information of communication required for the phase of the project.

Examples of the “communication information” herein include a thread, a message, email, and the like.

Examples of the “phase” include a document creating phase, a consensus creating phase, and the like.

Examples of the “model information” include a condition such as a number of comments on an outcome, and the like.

Examples of the “communication status” include prediction of a risk, and the like.

In addition, the communication-status estimating module 145 may further acquire member information indicating the members of the project.

Furthermore, the communication-status estimating module 145 may acquire the second phase. For example, the communication-status estimating module 145 may acquire, as the second phase, a phase in which the project is supposed to be planed.

Furthermore, for example, the communication-status estimating module 145 may acquire, as the second phase, a phase estimated on the basis of the outcome of the project.

Subsequently, the communication-status estimating module 145 extracts the feature of the communication information in accordance with the model information and predicts a risk on the basis of whether the feature satisfies a predetermined condition.

For example, if the phase is the document creating phase (as a specific example, the specification creating phase or the like), a comment (including a message) on a document that is an outcome in the phase may be extracted as the communication information. In addition, a comment and a reply to the comment may serve as the communication information. For example, if there is a review comment (e.g., criticism) without any reply, the presence of a risk may be predicted.

If the phase is the consensus creating phase (as a specific example, the development planning phase or the like), information indicating whether a consensus is reflected on a document that is an outcome in the phase may serve as the communication information. For example, if a consensus is not written in a comment or a document, the presence of a risk may be predicted. In addition, if a ratio of the number of messages including a consensus to the total number of messages in the phase is less than or equal to a predetermined ratio, the presence of a risk may be predicted.

If the phase is the discussion phase, information indicating a discussion in the phase may serve as the communication information.

The communication-status estimating module 145 may estimate the first phase on the basis of the communication information of the project.

Examples of the communication status other than the prediction of a risk estimated by the communication-status estimating module 145 include “the number of members had better be increased”, “discussion had better be made after acquiring new information”, and the like in the case of communication in the “discussion phase” by estimating the status as a “status of having the same discussion”.

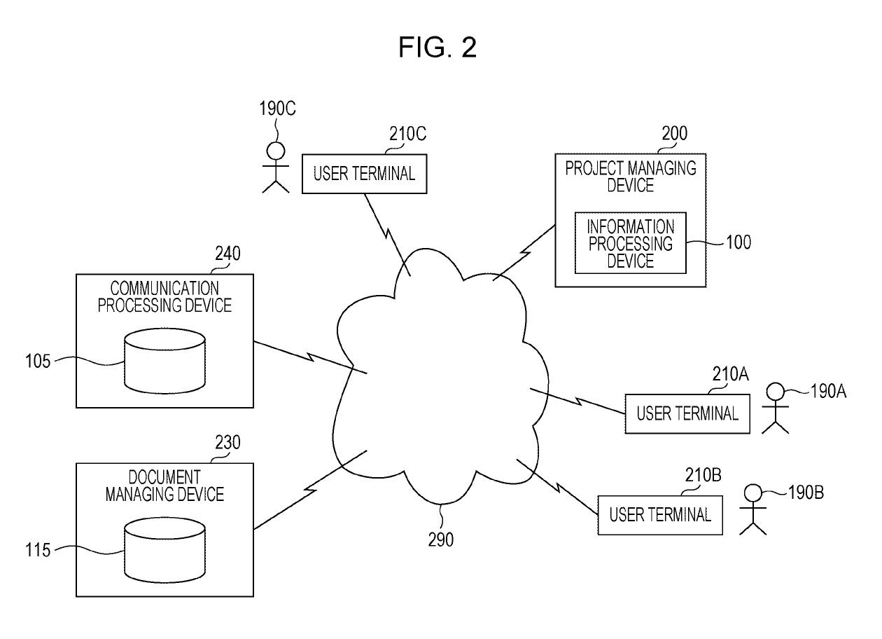

FIG. 2 illustrates a system configuration example using the exemplary embodiment.

A project managing device 200 that is a server has a function of managing a project and has a function of the information processing device 100. The communication-information storing module 105 and the outcome storing module 115 may not only be included in the information processing device 100 but also be included in an external device. As an example of the external device, a document managing device 230 may include the outcome storing module 115, and a communication processing device 240 may include the communication-information storing module 105.

The document managing device 230 has a document managing function. For example, a document can be stored, and another user can view, download, and co-edit the document, for example.

The communication processing device 240 has a communication function. Examples include an email system, a chat system, an SNS, an electronic sticky note processing device, and the like.

The project managing device 200, a user terminal 210A, a user terminal 210B, a user terminal 210C, the document managing device 230, and the communication processing device 240 are connected to each other via a communication line 290. The communication line 290 may be a wireless line, a wired line, or a combination thereof, and may be, for example, the Internet, an intranet, or the like as a communication infrastructure. In addition, the functions of the project managing device 200, the document managing device 230, and the communication processing device 240 may be realized as a cloud service. A plurality of users 190 conduct a project. As one of the users 190, for example, the user 190A who is a project manager checks a communication status such as a .predicted risk of the project by using the information processing device 100 of the project managing device 200.

FIGS. 3A and 3B illustrate processing examples according to the exemplary embodiment.

On a project management screen 300 illustrated in FIG. 3A, processing is performed to display or attach a comment (an example of the communication information) on a document that is an outcome in the project. Specifically, the project management screen 300 is a bulletin board Web application, for example.

On the project management screen 300, a project-name display region 305, an update button 310, a “review on document” button 315, a supervising status change button 320, a communication-information table 325, a reply button 335, a message button 337, a review button 339, a communication-details display region 340 are displayed.

In the case where the update button 310 is selected, details of the communication-information table 325 in the project are updated to the latest state.

If the “review on document” button 315 is selected, a document display screen 350 illustrated in the example in FIG. 3B is displayed.

If the supervising status change button 320 is selected, the status of the project supervised by a member who is operating the project managing device 200 is displayed, and the status is made changeable.

The communication-information table 325 includes a title column 327, an author column 329, and an operation column 331. The title column 327 displays the title of a document or a comment. The author column 329 displays an author of the document or the comment. The operation column 331 displays an operation that can be performed on the document or the comment. Examples of the operation that can be performed on the document or the like include display, modification, and the like of the document or the comment.

If the reply button 335 is selected, processing is performed to reply a comment selected in the communication-information table 325. Specifically, an electronic sticky note on which a reply to the comment is written can be created and pasted onto a document that is the target.

If the message button 337 is selected, processing is performed to create a new message. Specifically, an electronic sticky note on which a comment is written is pasted onto a document that is the target.

If the review button 339 is selected, processing is performed to review the project. Specifically, review participants are informed of holding a review, and the review is held at a scheduled date and time.

In the communication-details display region 340, details of communication in a row selected in the communication-information table 325 are displayed. In the example in FIG. 3A, the first row of the communication-information table 325 is selected, and its details are displayed.

The document display screen 350 illustrated in FIG. 3B is displayed if the “review on document” button 315 is selected. On the document display screen 350, processing is performed to display or attach a comment (an example of the communication information) on a document that is an outcome in the project.

On the document display screen 350, a document 355 (whose title is “ABC . . . ” in the example in FIG. 3A) created in the target project is displayed. Then, as a result of communication, an electronic sticky note 360, an electronic sticky note 365, and an electronic sticky note 370 are pasted onto the document 355.

The electronic sticky note 360 corresponds to the second row of the communication-information table 325, the electronic sticky note 365 corresponds to the third row of the communication-information table 325, and the electronic sticky note 370 corresponds to the fourth row of the communication-information table 325.

Then, the numbers of replies to these comments (the electronic sticky note 360, the electronic sticky note 365, and the electronic sticky note 370) are displayed (in a number-of-replies display region 362, a number-of-replies display region 367, and a number-of-replies display region 372, respectively).

These comments and replies are stored in the communication-information storing module 105.

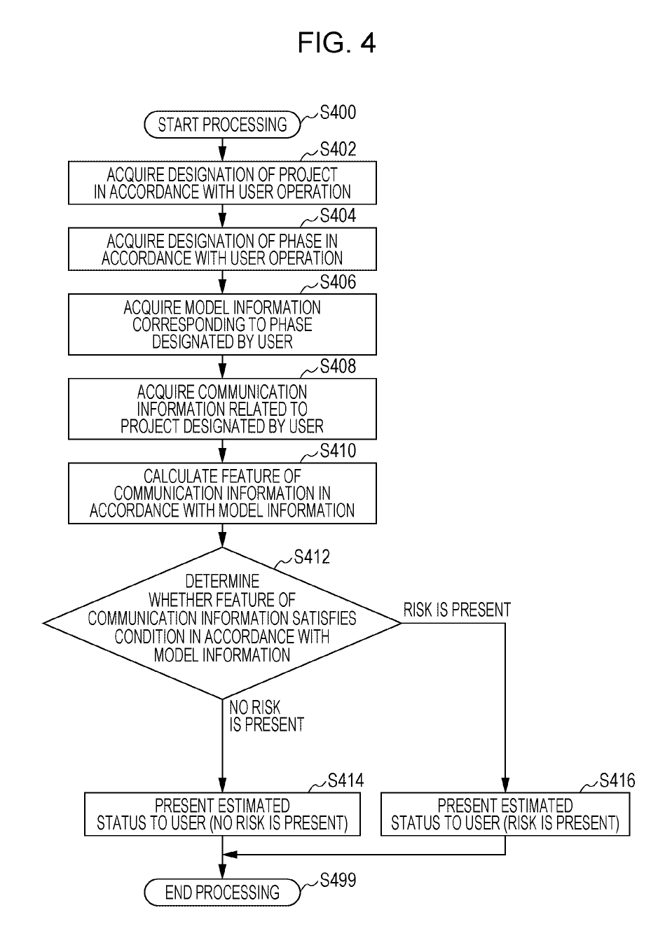

FIG. 4 is a flowchart illustrating a processing example according to the exemplary embodiment.

In step S400, the processing is started.

In step S402, the project-information-and-phase-information acquiring module 110 acquires designation of a project in accordance with an operation of a user who is a project manager, for example. In general, the user participates in a plurality of projects, and a project for which a communication status is desired to know is selected.

In step S404, the project-information-and-phase-information acquiring module 110 acquires designation of a phase in accordance with a user operation. In general, the project includes a plurality of phases, and a phase for which a communication status is desired to know is selected.

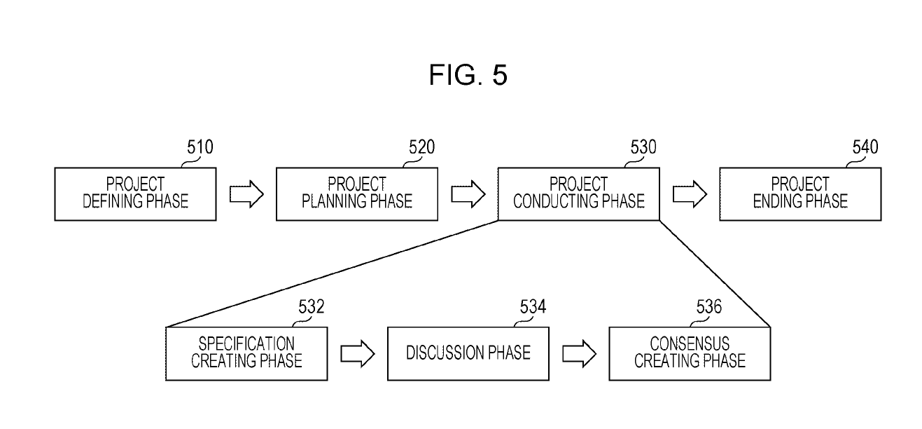

FIG. 5 illustrates an example of a phase that is a processing target according to the exemplary embodiment.

In this project, a project defining phase 510 is followed by a project planning phase 520, the project planning phase 520 is followed by a project conducting phase 530, and the project conducting phase 530 is followed by a project ending phase 540. A phase may further include a plurality of phases. For example, in the project conducting phase 530, a specification creating phase 532 is followed by a discussion phase 534, and the discussion phase 534 is followed by a consensus creating phase 536.

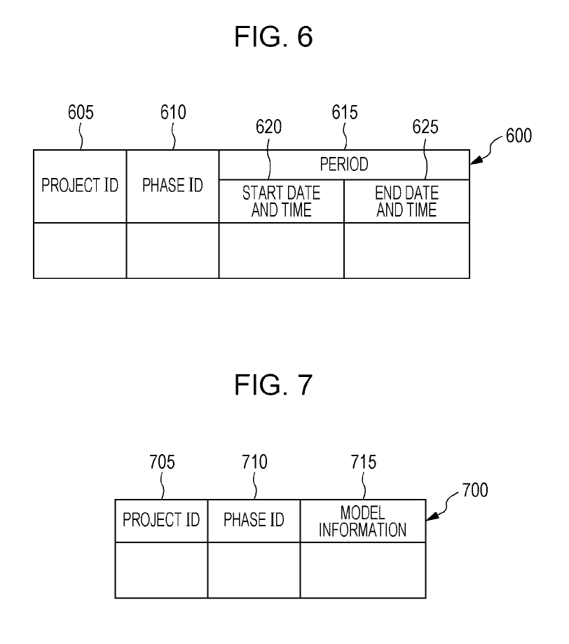

The phases in the project are managed by using, for example, a project planning table 600. FIG. 6 illustrates a data structure example of the project planning table 600. The project planning table 600 includes a project ID column 605, a phase ID column 610, and a period column 615, and the period column 615 includes a start date and time column 620 and an end date and time column 625. The project ID column 605 stores information (project identification (ID)) for uniquely identifying a project in the exemplary embodiment. The phase ID column 610 stores information (phase ID) for uniquely identifying a phase in the exemplary embodiment. The period column 615 stores a scheduled period of the phase. The start date and time column 620 stores a scheduled start date and time of the phase. The end date and time column 625 stores a scheduled end date and time of the phase.

In step S406, the communication-status estimating module 145 acquires model information corresponding to the phase designated by the user. For example, the communication-status estimating module 145 acquires the model information on the basis of the phase designated in step S404 by using a model information table 700. FIG. 7 illustrates a data structure example of the model information table 700.

The model information table 700 includes a project ID column 705, a phase ID column 710, and a model information column 715. The project ID column 705 stores the project ID. The phase ID column 710 stores the phase ID. The model information column 715 stores model information in the phase indicated by the phase ID.

In step S408, the communication-status estimating module 145 acquires communication information related to the project designated by the user from the communication-information storing module 105. For example, the communication-status estimating module 145 acquires the communication information table 800 as the communication information. FIG. 8 illustrates a data structure example of the communication information table 800. The communication information table 800 includes a communication ID column 805, a project ID column 810, a phase ID column 815, a date and time column 820, the communication type column 825, an author column 830, a details column 835, and a conclusion column 840. The communication ID column 805 stores information (communication ID) for uniquely identifying the communication information in the exemplary embodiment. The project ID column 810 stores the project ID of the project in which communication corresponding to the communication information was performed. The phase ID column 815 stores the phase ID of the phase in which the communication was performed. The date and time column 820 stores the date and time (year, month, day, hour, minute, second, unit smaller than the second, or a combination thereof) at which the communication was performed. The communication type column 825 stores the type of communication. The communication type column 825 stores, for example, information indicating a thread, a message, email, or the like. The author column 830 stores an author. The details column 835 stores details of the communication information. The conclusion column 840 stores information indicating whether the communication information is a conclusion, for example (or may be a review, a reply, a comment, a suggestion, or the like other than the conclusion). For example, when creating the communication information, the author may designate attribute information indicating whether the communication information is a conclusion, it may be determined that the communication information is a conclusion or the like if the communication information includes a predetermined term, or it may be determined whether the communication information is a conclusion by using a model created through machine learning using the communication information that has already been collected and its attribute information as teacher data.

In step S408, the communication-status estimating module 145 may further acquire a document that is an outcome related to the project designated by the user from the outcome storing module 115. For example, the communication-status estimating module 145 acquires an outcome information table 900 as the “document that is an outcome”. FIG. 9 illustrates a data structure example of the outcome information table 900. The outcome information table 900 includes a document ID column 905, a project ID column 910, a phase ID column 915, a creation date and time column 920, an author column 925, and a document column 930. The document ID column 905 stores information (document ID) for uniquely identifying a document in the exemplary embodiment. The project ID column 910 stores a project ID of a project in which the document was created. The phase ID column 915 stores a phase ID of a phase in which the document was created. The creation date and time column 920 stores the date and time at which the document was created. The author column 925 stores an author of the document. The document column 930 includes the document. The target to be stored may be the document itself or may be information indicating the location where the document is stored (e.g., uniform resource locator (URL)).

In step S410, the communication-status estimating module 145 calculates a feature of the communication information in accordance with the model information. For example, as described above, the feature may be a comment (or a reply to the comment) on a document, information indicating whether a consensus is reflected, information indicating a discussion, or the like.

In step S412, it is determined whether the feature of the communication information satisfies a condition in accordance with the model information. If “NO RISK IS PRESENT” is determined, the processing proceeds to step S414; if “RISK IS PRESENT” is determined, the processing proceeds to step S416. As described above, the condition is determined in the model information. For example, if the ratio of threads in which a message determined as a consensus (conclusion) is written is less than a threshold, it is determined that a risk is present in the development planning phase.

As a specific example, the processing is performed as follows.

total number of threads (total number of messages): 100

number of threads including consensus (conclusion) (number of messages including consensus): 25

ratio of consensus: 25%

threshold: 20%

In this example, since the ratio is no less than the threshold, it is determined that “NO RISK IS PRESENT”.

In step S414, an estimated status is presented to the user. Specifically, the user is informed that the status is “NO RISK IS PRESENT” in this phase.

In step S416, an estimated status is presented to the user. Specifically, the user is informed that the status is “RISK IS PRESENT” in this phase. The reason therefor may also be presented. In the above-described example, a message indicating that the number of messages including consensus does not reach the threshold is presented.

In step S499, the processing ends.

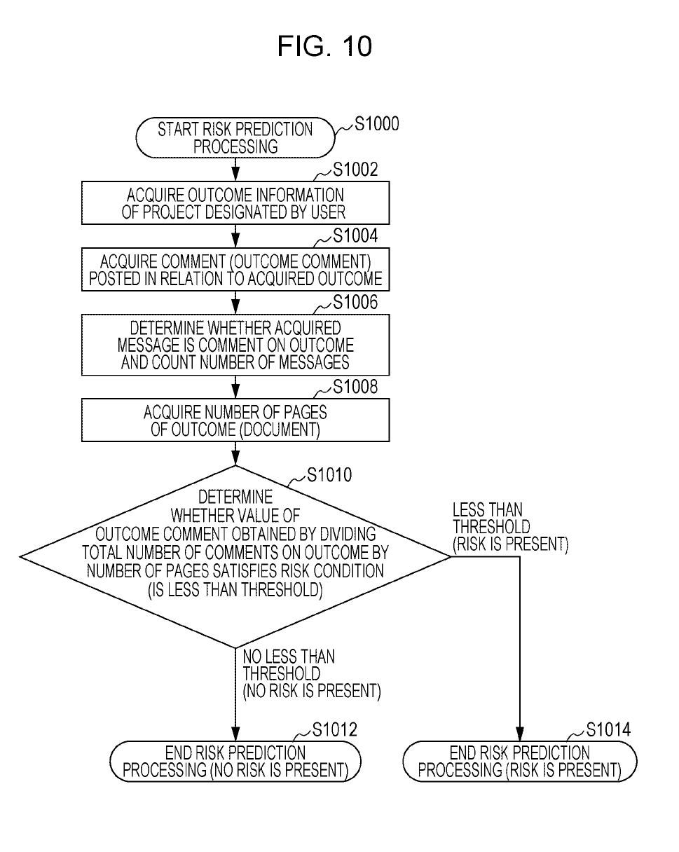

FIG. 10 is a flowchart illustrating a processing example according to the exemplary embodiment. A risk is predicted on the basis of a productivity of comments on a document that is an outcome.

The processing from step S408 to step S412 illustrated in the example in FIG. 4 may be replaced with the flowchart illustrated in the example in FIG. 10.

In step S1000, risk prediction processing is started.

In step S1002, outcome information of the project designated by a user is acquired.

In step S1004, a comment (outcome comment) posted in relation to the acquired outcome is acquired. Specifically, as described above, an electronic sticky note pasted onto a document is acquired.

In step S1006, it is determined whether the acquired message is a comment on the outcome, and the number of such messages is counted. As described above, it may be determined whether the message is a comment on the basis of attribute information (the conclusion column 840 of the communication information table 800) of the comment, it may be determined that the message is a comment if the message includes a predetermined term, or it may be determined whether the message is a comment by using a model created through machine learning.

In step S1008, the number of pages of the outcome (document) is acquired.

In step S1010, it is determined whether a value of the outcome comment obtained by dividing the total number of comments on the outcome by the number of pages satisfies a risk condition (is less than a threshold). If the value is “NO LESS THAN THRESHOLD (NO RISK IS PRESENT)”, the processing proceeds to step S1012; if the value is “LESS THAN THRESHOLD (RISK IS PRESENT)”, the processing proceeds to step S1014.

Specifically, the processing is performed as follows.

number of comments on outcome: 40

number of pages of outcome: 10

value obtained by dividing number of comments by number of pages: 4

threshold: 5

In this example, since the value is less than the threshold, it is determined that “RISK IS PRESENT”.

In step S1012, the risk prediction processing ends (no risk is present). Subsequently, the processing proceeds to step S414 illustrated in the example in FIG. 4.

In step s1014, the risk prediction processing ends (a risk is present). Subsequently, the processing proceeds to step S416 illustrated in the example in FIG. 4.

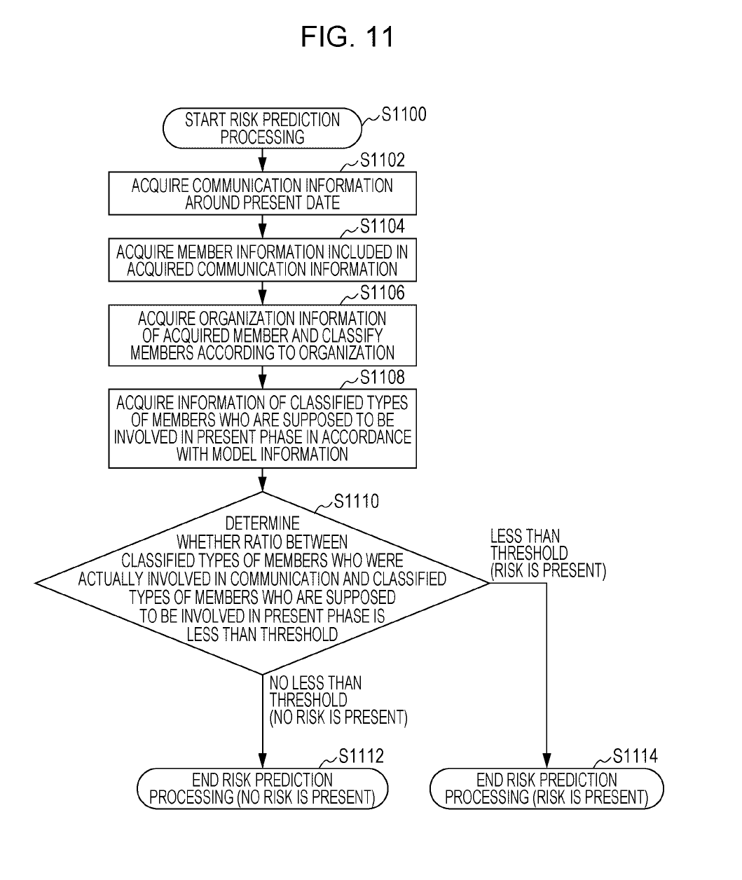

FIG. 11 is a flowchart illustrating a processing example according to the exemplary embodiment. A risk is predicted on the basis of whether a member who is supposed to be involved in accordance with a phase of a project is participating.

The processing from step S408 to step S412 illustrated in the example in FIG. 4 may be replaced with the flowchart illustrated in the example in FIG. 11.

In step S1100, risk prediction processing is started.

In step S1102, communication information around the present date is acquired. For example, communication information in a month is acquired.

In step S1104, information of members included in the acquired communication information is acquired. As the information of the members, for example, information of persons who performed communication (the author column 830 of the communication information table 800) is acquired.

In step S1106, organization information of members in the acquired information is acquired, and the members are classified according to organization. For example, the organization information is acquired by using user information that is stored with a user ID of a user and the organization information of the user (including an organization to which the user belongs, a position of the user, and the like) associated with each other. The members may be classified into the following types: a leader (manager, general manager, or the like), a normal member, and the like.

In step S1108, information of the classified types of members who are supposed to be involved in the present phase is acquired in accordance with the model information. The model information here defines the information of the classified types (organization information) of members in each phase.

In step S1110, it is determined whether a ratio between classified types of members who were actually involved in communication and classified types of members who are supposed to be involved in the present phase is less than a threshold. If it is determined that the ratio is “NO LESS THAN THRESHOLD (NO RISK IS PRESENT)”, the processing proceeds to step S1112. If it is determined that the ratio is “LESS THAN THRESHOLD (RISK IS PRESENT)”, the processing proceeds to step S1114. That is, it is determined whether the ratio of the “classified types of members who were actually involved in communication” to the “classified types of members who are supposed to be involved in the present phase” defined in the model information is less than the threshold.

As a first specific example, the processing is performed as follows. In the following examples (first to third specific examples), the threshold ratio is 60%.

members who were actually involved: team leader, normal member

members who are supposed to be involved in document creating phase: team leader, normal member

In this example, the “classified types of members who are supposed to be involved in the present phase” defined in the model information are two types of positions, which are “team leader” and “normal member”. In addition, the “classified types of members who were actually involved in communication” are also the same two types of positions, which are “team leader” and “normal member”. Thus, the ratio is 100%, and it is determined that “NO RISK IS PRESENT”.

As a second specific example, the processing is performed as follows.

members who were actually involved: team leader, normal member

members who are supposed to be involved in consensus creating phase: general manager, group leader, normal member

In this example, the “classified types of members who are supposed to be involved in the present phase” defined in the model information are three types of positions, which are “general manager”, “group leader”, and “normal member”. However, the “classified types of members who were actually involved in communication” are “team leader” and “normal member”, which lacks for “general manager” and “group leader”. Thus, the ratio is 33%, and it is determined that “RISK IS PRESENT”.

As a third specific example, the processing is performed as follows.

members who were actually involved: member from plan department, member from development department

members who are supposed to be involved in testing phase for product development: member from development department, member from quality assurance department

In this example, the “classified types of members who are supposed to be involved in the present phase” defined in the model information are two types of positions, which are “member from development department” and “member from quality assurance department”. However, the “classified types of members who were actually involved in communication” are “member from plan department” and “member from development department”, which lacks for “member from quality assurance department”. Thus, the ratio is 50%, and it is determined that “RISK IS PRESENT”.

In step S1112, the risk prediction processing ends (no risk is present). Subsequently, the processing proceeds to step S414 illustrated in the example in FIG. 4.

In step S1114, the risk prediction processing ends (a risk is present). Subsequently, the processing proceeds to step S416 illustrated in the example in FIG. 4.

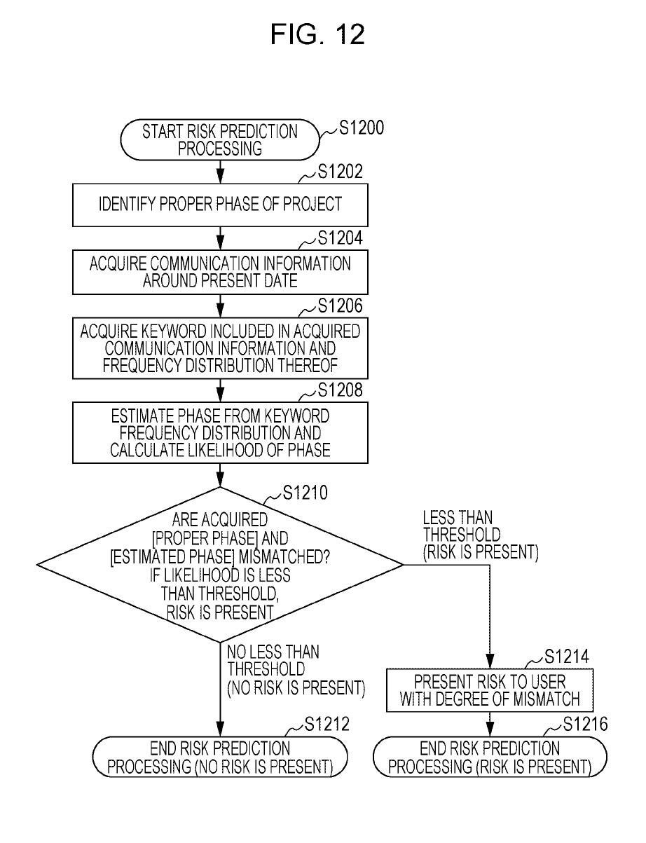

FIG. 12 is a flowchart illustrating a processing example according to the exemplary embodiment. A risk is predicted on the basis of a degree of mismatch between a phase that is estimated on the basis of communication information and a proper phase.

The processing from step S408 to step S412 illustrated in the example in FIG. 4 may be replaced with the flowchart illustrated in the example in FIG. 12.

In step S1200, risk prediction processing is started.

In step S1202, a proper phase that the project is supposed to be in at the present time is identified.

For example, the phase is identified (1) by designating the proper phase by a user or (2) on the basis of project information (i.e., schedule information, an example of the model information). For example, in the case where the project information defines that “November is a development planning phase”, “December is a designing phase”, and “January is an implementing phase”, if the present time is in December, the phase is identified as the “designing phase”.

In step S1204, communication information around the present date is acquired. For example, communication information in a month is acquired.

In step S1206, a keyword included in the acquired communication information and a frequency distribution thereof are acquired.

In step S1208, a phase is estimated on the basis of the keyword frequency distribution, and a likelihood of the phase is calculated. For example, if a term “design” is included and its frequency is high, the phase is estimated to be the designing phase. Note that the “frequency is high” herein means a case in which the number of appearances of a keyword is greater than or equal to a predetermined threshold, or a case in which a calculated ratio of the number of appearances of a keyword to the number of all terms in the communication information is greater than or equal to a predetermined threshold, for example. In addition, the likelihood is calculated in accordance with a predetermined rule. As the rule, for example, a first threshold and a second threshold (the second threshold is greater than the first threshold) may be defined in the above-described example of the term “design”. If the frequency of the term “design” is greater than or equal to the first threshold and less than the second threshold, the likelihood may be set to 60%, and if the frequency of the term “design” is greater than or equal to the second threshold, the likelihood may be set to 80%.

In step S1210, it is determined whether the acquired [proper phase] and the [estimated phase] are mismatched. If the likelihood of the [estimated phase] being the [proper phase] is less than the threshold, it is determined that a risk is present. That is, if the likelihood is “NO LESS THAN THRESHOLD (NO RISK IS PRESENT)”, the processing proceeds to step S1212; if the likelihood is “LESS THAN THRESHOLD (RISK IS PRESENT)”, the processing proceeds to step S1214.

As a specific example, the processing is performed as follows.

proper phase at present: implementing phase

likelihood of present phase being implementing phase: 60%

threshold: 80%

In this example, since the likelihood is less than the threshold, it is determined that “RISK IS PRESENT”.

In step S1212, the risk prediction processing ends (no risk is present). Subsequently, the processing proceeds to step S414 illustrated in the example in FIG. 4.

In step S1214, a risk with a degree of mismatch is presented to a user. As the degree of mismatch, for example, a message saying “the present phase is the designing phase although it is supposed to be the implementing phase” or the like is presented.

In step S1216, the risk prediction processing ends (a risk is present). Subsequently, the processing proceeds to step S416 illustrated in the example in FIG. 4.

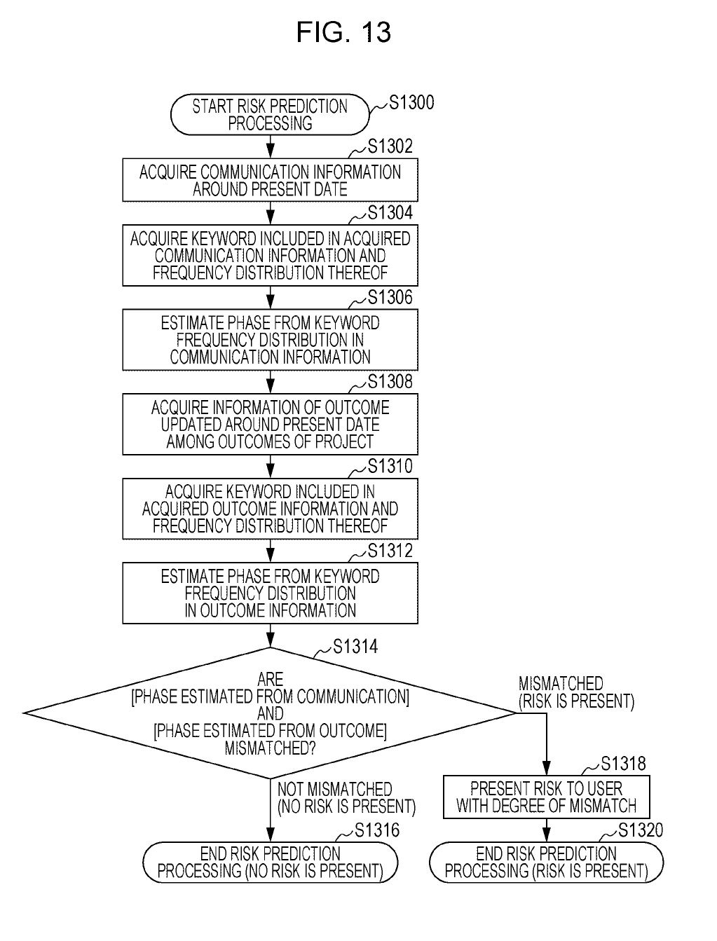

FIG. 13 is a flowchart illustrating a processing example according to the exemplary embodiment. A risk is predicted on the basis of a degree of mismatch between a phase that is estimated on the basis of communication information and a phase estimated on the basis of outcome information.

The processing from step S408 to step S412 illustrated in the example in FIG. 4 may be replaced with the flowchart illustrated in the example in FIG. 13.

In step S1300, risk prediction processing is started.

In step S1302, communication information around the present date is acquired. For example, communication information in a month is acquired.

In step S1304, a keyword included in the acquired communication information and a frequency distribution thereof are acquired.

In step S1306, a phase is estimated on the basis of the keyword frequency distribution in the communication information. For example, if a term “design” is included and its frequency is high, the phase is estimated to be a designing phase.

In step S1308, outcome information that is updated around the present date is acquired among outcomes of the project. For example, outcome information in a month is acquired. Documents created in this period for the project are collected.

In step S1310, a keyword included in the acquired outcome information and a frequency distribution thereof are acquired.

In step S1312, a phase is estimated on the basis of the keyword frequency distribution in the outcome information. The phase is estimated as in step S1306 by using the outcome information as the target.

Alternatively, the following processing may be performed in step S1312.

A likelihood of the phase being the phase estimated in step S1306 may be calculated on the basis of the keyword frequency distribution in the outcome information. For example, if the phase is estimated to be the designing phase in step S1306, the likelihood of the phase being the designing phase may be calculated on the basis of the frequency distribution of the keyword “design” in the outcome information. That is, the likelihood of a predetermined phase (the phase estimated in step S1306) may be calculated in step S1312. Note that the likelihood is calculated in accordance with the predetermined rule as described above.

In step S1314, it is determined whether the [phase estimated from communication] and the [phase estimated from outcome] are mismatched. If they are not mismatched, the processing proceeds to step S1316; if they are mismatched, the processing proceeds to step S1318.

As a specific example, the processing is performed as follows.

estimation result in step S1306: designing phase

estimation result in step S1312: development planning phase

In this example, since the estimated phases are different from each other, it is determined that “RISK IS PRESENT”.

In addition, in the case where the likelihood of the phase being the phase estimated in step S1306 is calculated in step S1312, if the likelihood is “NO LESS THAN THRESHOLD (NO RISK IS PRESENT)”, the processing proceeds to step S1316, and if the likelihood is “LESS THAN THRESHOLD (RISK IS PRESENT)”, the processing proceeds to step S1318.

As a specific example, the processing is performed as follows.

phase estimated from communication: implementing phase

likelihood of implementing phase estimated from outcome: 60%

threshold: 80%

In this example, since the likelihood is less than the threshold, it is determined that “RISK IS PRESENT”.

In step S1316, the risk prediction processing ends (no risk is present). Subsequently, the processing proceeds to step S414 illustrated in the example in FIG. 4.

In step S1318, a risk with a degree of mismatch is presented to a user. As the degree of mismatch, for example, a message saying “the phase estimated from the outcome is the designing phase although the phase estimated from communication is the implementing phase” or the like is presented.

In step S1320, the risk prediction processing ends (a risk is present). Subsequently, the processing proceeds to step S416 illustrated in the example in FIG. 4.

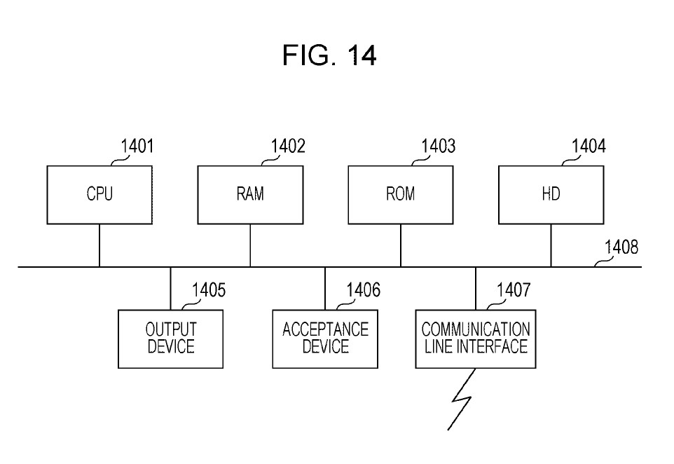

Note that a hardware configuration of a computer that executes a program according to the exemplary embodiment is, as illustrated in FIG. 14, a typical computer and is specifically a computer that may serve as a personal computer or a server. That is, as a specific example, a CPU 1401 is used as a processing unit (computation unit), and a RAM 1402, a read only memory (ROM) 1403, and a hard disk drive (HD) 1404 are used as memory devices. The HD 1404 may be, for example, a hard disk or a solid state drive (SSD). The computer includes the CPU 1401, the RAM 1402, the ROM 1403, the HD 1404, an acceptance device 1406, an output device 1405, a communication line interface 1407, and a bus 1408 that connects these components to each other for data transfer. The CPU 1401 executes a program implementing the project-information-and-phase-information acquiring module 110, the outcome-comment-information acquiring module 125, the outcome-information acquiring module 130, the comment-productivity determining module 135, the presenting module 140, the communication-status estimating module 145, and the like. The RAM 1402 stores the program and data. The ROM 1403 stores a program and the like for starting the computer. The HD 1404 is an auxiliary memory device (which may be a flash memory or the like) having functions of the communication-information storing module 105, the outcome storing module 115, the model-information storing module 120, and the like. The acceptance device 1406 accepts data in accordance with a user operation (including gestures, voice, line of sight, and the like) on a keyboard, a mouse, a touchscreen, a microphone, a camera (including a line-of-sight detecting camera or the like), or the like. The output device 1405 is a cathode ray tube (CRT), a liquid crystal display, a speaker, or the like. The communication line interface 1407 is a network interface card or the like, and is connected to a communication network. A plurality of computers each having the above configuration may be connected to each other via a network.

Elements of the exemplary embodiment described above that are implemented by a computer program are implemented by causing a system having this hardware configuration to read a computer program, which is software, and the software and hardware resources to cooperate with each other to realize the exemplary embodiment described above.

The hardware configuration of the image processing device illustrated in FIG. 14 is one of exemplary configurations. The exemplary embodiment is not limited to the configuration illustrated in FIG. 14 and may be any configuration as long as it is possible to execute the modules described in the exemplary embodiment. For example, some modules may be configured by dedicated hardware (e.g., application specific integrated circuit (ASIC)), some modules may be included in an external system and may be connected via a communication line, and a plurality of systems illustrated in FIG. 14 may be connected to each other via a communication line and may operate in cooperation with each other. In particular, some modules may be incorporated in, other than the personal computer, a mobile information communication device (e.g., a mobile phone, a smartphone, a mobile device, or a wearable computer), an information home appliance, a robot, a copying machine, a facsimile, a scanner, a printer, a multifunction peripheral (an image processing device having any two or more of a scanner function, a printer function, a copying machine function, a facsimile function, and the like), and the like.

The above-described program may be provided by being stored in a medium. Alternatively, the program may be provided by using a communication means. In such a case, for example, the program may correspond to a computer readable medium storing a program.

The term “computer readable medium storing a program” refers to a computer readable medium that stores a program and that is used to, for example, install, execute, and distribute the program.

Examples of the medium include the following: a digital versatile disc (DVD), such as “DVD-R, DVD-RW, DVD-RAM, and the like” as standardized by the DVD Forum or “DVD+R, DVD+RW, and the like” as standardized by the DVD+RW Alliance; a compact disc (CD), such as a CD read only memory (CD-ROM), a CD recordable (CD-R), or a CD rewritable (CD-RW); a Blu-ray Disc (registered trademark); a magneto-optical disk (MO); a flexible disk (FD); a magnetic tape; a hard disk; a read only memory (ROM); an electrically erasable programmable read only memory (EEPROM) (registered trademark); a flash memory; a random access memory (RAM); and a secure digital (SD) memory card.

A part or all of the program may be, for example, recorded on the medium and stored or distributed. Alternatively, a part or all of the program may be transmitted by communication using a transmission medium, such as a wired network used for a local area network (LAN), a metropolitan area network (MAN), a wide area network (WAN), the Internet, an intranet, or an extranet; a wireless communication network; or a combination thereof. Further alternatively, a part or all of the program may be transmitted on a carrier wave.

The above-described program may be a part or all of another program, or may be recorded on a medium together with another program. The program may be divided into sub-parts and recorded on a plurality of media. The program may be recorded in any form, such as by being compressed or encrypted, as long as it is possible to restore the program.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
an acquiring unit that acquires communication information related to a project, phase information indicating a phase of the project, and model information of communication required for the phase of the project; and
a presenting unit that presents a communication status in the phase of the project on the basis of the model information corresponding to the phase information and on the basis of the communication information.

2. The information processing device according to claim 1, further comprising
a predicting unit that extracts a feature of the communication information in accordance with the model information and predicts a risk on the basis of whether the feature satisfies a predetermined condition,
wherein the representing unit represents a result predicted by the predicting unit as the communication status.

3. The information processing device according to claim 2,
wherein, if the phase is a document creating phase, the communication information is a comment on a document that is an outcome in the phase.

4. The information processing device according to claim 3,
wherein the communication information is the comment and a reply to the comment.

5. The information processing device according to claim 2,
wherein, if the phase is a consensus creating phase, the communication information is information indicating whether a consensus is reflected on a document that is an outcome in the phase.

6. The information processing device according to claim 1,
wherein, if the phase is a discussion phase, the communication information is information indicating a discussion in the phase.

7. The information processing device according to claim 1,
wherein the acquiring unit further acquires member information indicating a member of the project, and
wherein the presenting unit presents the communication status in the phase of the project on the basis of the model information corresponding to the phase information and on the basis of the member information.

8. The information processing device according to claim 1, further comprising:
a phase estimating unit that estimates a first phase on the basis of the communication information related to the project; and
a phase-information acquiring unit that acquires a second phase,
wherein the presenting unit presents the communication status in accordance with the first phase and the second phase.

9. The information processing device according to claim 8,
wherein the phase-information acquiring unit acquires, as the second phase, a phase in which the project is supposed to be planed, and
wherein the presenting unit presents, as the communication status, information as to whether the first phase and the second phase are different from each other.

10. The information processing device according to claim 8,
wherein the phase-information acquiring unit acquires, as the second phase, a phase estimated on the basis of an outcome of the project, and
wherein the presenting unit presents, as the communication status, information as to whether the first phase and the second phase are different from each other.

11. A non-transitory computer readable medium storing a program causing a computer to execute a process for information processing, the process comprising:
acquiring communication information related to a project, phase information indicating a phase of the project, and model information of communication required for the phase of the project; and
presenting a communication status in the phase of the project on the basis of the model information corresponding to the phase information and on the basis of the communication information.

12. An information processing device comprising:
acquiring means for acquiring communication information related to a project, phase information indicating a phase of the project, and model information of communication required for the phase of the project; and
presenting means for presenting a communication status in the phase of the project on the basis of the model information corresponding to the phase information and on the basis of the communication information.
